(19) United States
(12) Patent Application Publication
(10) Pub. No.: US 2007/0216150 A1
(43) Pub. Date: Sep. 20, 2007

(54) Belt Roller for a Safety Belt System

(75) Inventor: Gerd Stueckle, Hildrizhausen (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, STUTTGART (DE)

(21) Appl. No.: 10/580,116

(22) PCT Filed: Oct. 28, 2004
(86) PCT No.: PCT/EP04/12205

§ 371 Date: Jan. 17, 2007

(30) Foreign Application Priority Data
Nov. 19, 2003 (DE) 103 54 071.7

(51) Int. Cl. B60R 22/34

(52) U.S. Cl. 280/807

(57) ABSTRACT

The invention relates to a belt roller (1) for a safety belt system in a motor vehicle, having a device (3) which locks the belt roll (2) in the event of a belt velocity which exceeds a threshold value and/or in the event of a vehicle deceleration/acceleration which exceeds a threshold value, the belt roll (2) having a torsion bar (5) which runs in its axial direction (4) and forms a torsionally resilient element, the torsion bar (5) being connected at one end to the locking device (3) and at the other end to the belt roll (2), and it being possible to set the maximum possible torsional resistance at least as a function of the weight of the respective user of the safety belt (22) by automatically altering the active portion of the torsion bar. In this context, it is essential to the invention that at least one coupling element (6), which can be adjusted on the torsion bar (5) by axial movement between an active position, in which it is rotationally fixedly connected to the torsion bar (5) on one side and the belt roll (2) on the other side, and a passive position, in which it is rotationally fixedly connected only to the belt roll (2) or only to the torsion bar (5), is provided between the locking device (3), on one side, and the connection of the torsion bar (5) to the belt roll (2), on the other side.

This application is a national phase application of International application PCT/EP2004/012205 filed Oct. 28, 2004 and claims the priority of German application No. 103 54 071.7, filed Nov. 19, 2003, the disclosure of which are expressly incorporated by reference herein.

### BACKGROUND AND SUMMARY OF THE INVENTION

The present invention relates to a belt roller for a safety belt system in a motor vehicle.

DE 43 44 656 C1 has disclosed a belt roller for a safety belt system in a motor vehicle, having a device which locks the belt roll in the event of a predetermined jerk on the seat belt and/or a predetermined vehicle deceleration. In this case, the belt roll is connected to the locking device by a torsion bar which runs in its axial direction and forms a torsionally resilient element, and the torsion bar is coupled at one end to the locking device and at the other end to the belt roll, in such a manner that the maximum possible torsional resistance can be set at least as a function of the weight of the user of the safety belt by automatically altering the active portion of the torsion bar. The torsionally resilient torsion bar can be adjusted along its axis counter to a spring; an actuating device is provided for the adjustment, which actuating device is connected to a vehicle seat, for example via a wire pull, and is controlled, for example, as a function of the weight of the user of the safety belt. Axial displacement of the torsion bar counter to the spring reduces a moment of torsional resistance of the torsion bar, so that in each case the optimum moment of torsional resistance can be set for people of different weight.

DE 197 80 583 C1 has disclosed a belt retractor with controllable force-limiting device. The belt retractor has a blocking device which can be actuated in a vehicle-sensitive and/or seat-belt-sensitive manner, the belt retractor having, as force-limiting device, a torsion bar which is connected on one side to the shaft for winding up the belt and on the other side, via a profiled head, to a blocking lock member of the belt retractor. The torsion bar can be adapted to presettable load situations by altering a force transmission path between torsion bar and the shaft for winding up the belt. For this purpose, there are at least two force-limiting elements which are arranged in parallel or in series with respect to one another, can each be controlled independently by means of a switching device and of which one force-limiting element is formed by the torsion bar.

DE 197 80 583 C1 shows a belt roller in which two force-limiting elements which can be controlled independently of one another are provided, one of which force-limiting element is formed by a torsion bar.

The present invention deals with the problem of demonstrating an improved embodiment for a belt roller for a safety belt system, which with a simple structure can be individually adapted to particular conditions, for example in part determined by the vehicle occupant, in order in this way to minimize the risk of injury to a vehicle occupant in the event of the vehicle crashing.

The features according to the invention have the effect that in each case only one coupling element engages by way of its non-round external contour, for example by way of its cams, in a respectively associated cavity of the belt roll, so that a cavity is in each case assigned to only one coupling element. In addition, this offers the advantage that an actuating element which is required to move the coupling elements from the passive position into the active position or vice versa, such as for example a threaded spindle or a slide rod, can be guided from an actuating drive through the cavity inside the belt roll to the associated coupling element. Since, as mentioned above, each cavity is in each case assigned one coupling element, it is therefore possible to achieve a particularly compact design.

To set the active portion of the torsion bar, there are coupling elements which are arranged between the locking device on one side and the connection of the torsion bar to the belt roll on the other side and which can be adjusted on the torsion bar, axially with respect to the latter, between an active position and a passive position. In the active position, each coupling element is rotationally fixedly connected both to the torsion bar and to the belt roll, whereas in the passive position it is not rotationally fixedly connected to either the belt rolls or the torsion bar, or is rotationally fixedly connected only to the belt roll or only to the torsion bar. The distance between the locking device and the coupling element in the active position defines the active portion of the torsion bar and therefore the active moment of torsional resistance of the torsion bar. In addition, it is possible to influence the moment of torsional resistance by a suitable selection of material for the torsion bar and/or a cross section of the torsion bar in the active portion of the torsion bar.

In general, each coupling element is usually in the passive position and is only moved into the active position by an actuating drive in the event of a crash, with the result that the active moment of torsional resistance is increased by a shortening of the active portion of the torsion bar. However, it is also conceivable for the coupling element usually to be in the active position and to be moved into the passive position in the event of a crash, for example as a function of the body weight of the user of the safety belt and/or the vehicle deceleration/acceleration or a seat position, thereby reducing the active moment of torsional resistance. Therefore, in the event of the automatic actuating device failing, the maximum moment of torsional resistance would be preset, so that optimum retention can be achieved even for heavy vehicle occupants. The activation or deactivation of the coupling element takes place, for example, as a function of the abovementioned biometric data and thereby allows the safety belt system to be optimally matched to the particular crash situation or the particular user of the safety belt.

In principle, the coupling elements could also adopt their passive or active position on the seat assigned to the associated belt being occupied, as a function of the weight of the person occupying the seat, and retain the position adopted until occupancy of the seat changes.

According to a preferred embodiment of the solution according to the invention, the cross section of the torsion bar is designed to decrease conically starting from its clamping location assigned to the lockable device. This has the advantage that it is particularly simple to realize an adjustment of the coupling element from its passive position into its active position or vice versa on account of the conicity of the torsion bar. At the same time, as the cross section decreases, in addition to the selected distance between the coupling element in the active position and the locking device, it is also possible to influence the moment of torsional resistance of the torsion bar and therefore to influence the maximum possible limiting of belt force.

According to an advantageous refinement of the solution according to the invention, each coupling element is designed as a torsion-proof sleeve. This ensures that the coupling element transmits the moment introduced by the belt roll to the torsion bar in a manner which is stiff against twisting. At the same time, the coupling element designed as a torsion-proof sleeve offers the advantage that given suitable toothing it can easily be adjusted axially along the torsion bar.

In a particularly favorable embodiment of the invention, each coupling element has internal toothing and the torsion bar has external toothing which is complementary to or matches the internal toothing of the coupling element. Transmission of force by means of toothing ensures slip-free and play-free and therefore particularly accurate transmission of force, the coupling element in the active state engaging by way of the internal toothing in the matching or complementary external toothing of the torsion bar, whereas in the passive position it is rotationally fixedly connected either on the inner side to the torsion bar or on the outer side to the belt roller. The internal and external toothing have tooth peaks and tooth valleys which run parallel to the axis of the torsion bar and thereby allow particularly simple adjustment of the coupling element parallel to the tooth peaks or tooth valleys and parallel to the axis of the torsion bar.

According to a preferred embodiment of the solution according to the invention, each coupling element has an external contour which is not round, a cavity which runs inside the belt roll having an internal contour which substantially matches the external contour of the coupling element. As an external contour which is not round, it is possible, for example, to provide projecting cams which engage in corresponding cavities within the belt roll. The non-round external contour or the cams in this case ensure play-free and therefore extremely accurate transmission of a belt roll rotation to the coupling element and vice versa.

The actuating drive, which serves to adjust the coupling elements coaxially with respect to the torsion bar, may expediently be of reversible design, for example as an electric motor or a pneumatic drive. This offers the major advantage, in particular after a crash, that the coupling element can be moved back from its crash position into its starting position by means of the reversible actuating drive, in which case the belt roller can fundamentally be left in the vehicle and does not need to be replaced. This allows cost benefits to be achieved in particular during repair.

It will be understood that the features mentioned above and those which are yet to be explained below can be used not only in the combination indicated in each instance but also in other combinations or with stand-alone measures without departing from the scope of the present invention.

Preferred exemplary embodiments of the invention are illustrated in the drawings and explained in more detail in the description which follows; in the drawings, identical reference designations relate to identical or functionally equivalent or similar components.

Other objects, advantages and novel features of the present invention will become apparent from the following detailed description of the invention when considered in conjunction with the accompanying drawings for example.

### BRIEF DESCRIPTION OF THE DRAWINGS

FIG. 1 shows a belt roller according to an embodiment of the invention and also coupling elements shown on the outside,

FIG. 2 diagrammatically depicts a belt roll according to an embodiment of the invention with associated coupling elements,

FIG. 3a shows an illustration as in FIG. 1, but with a pyrotechnic actuating drive for the coupling element,

FIG. 3b shows an illustration as in FIG. 2, but with a different belt roll and a different coupling element,

FIG. 4 shows an illustration as in FIGS. 1 and 3a, but with a pneumatic actuating drive for the coupling element,

FIG. 5a shows an illustration as in FIGS. 1, 3a and 4, but with an electrical actuating drive for the coupling elements,

FIG. 5b shows a cross section through the electrical actuating drive shown in FIG. 5a.

### DETAILED DESCRIPTION

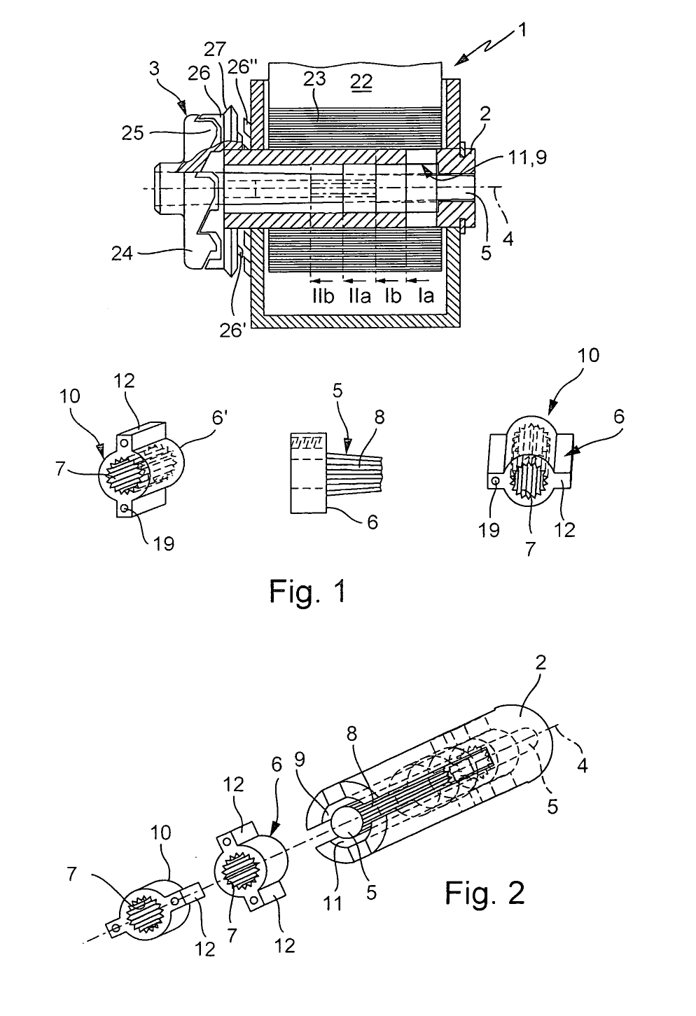

FIG. 1 shows a belt roller 1 which can be fixedly connected to a vehicle structure (not shown) and in which a belt roll 2, which carries a safety belt 22 in the form of a wound belt 23, is mounted such that it can rotate about an axis 4. The belt roll 2 is spring-loaded in the belt-retracting direction in a known way, so that the safety belt 22, when it is not in use, is retracted onto the belt roll 2, and when it is in use by a vehicle occupant is constantly pressed under a certain prestress against the body of the vehicle occupant. The belt roll 2 has a torsion bar 5 which runs in its axial direction 4, forms a torsionally resilient element and is connected to a toothed disk 24 of a locking device 3 in such a manner that the belt roll 2 is locked in the unwinding direction in the event of a belt velocity exceeding a threshold value and/or in the event of a vehicle deceleration exceeding a threshold value. For this purpose, at one end side the toothed disk 24 has toothing 25 which interacts with corresponding toothing 26 on a locking disk 27 which is held displace ably in the axial direction 4. On the opposite end side from the toothing 26, the locking disk 27 has second toothing 26′, which is designed to engage with further toothing 26″ on one of the cheeks of the belt roller 1. Whereas the vehicle belt 22 can be retracted and unwound without problems in the event of a slow movement of the belt, at increased belt velocity the locking disk 27 moves in the axial direction 4 onto the toothing 26″ and engages with the latter, with the result that the toothed disk 24 and therefore the belt roll 2 are fixed in place.

As shown in FIG. 1, the torsion bar 5 is connected at one end to the locking device 3 and at the other end to the belt roll 2, it being possible to set the maximum possible torsional resistance of the torsion bar 5 at least as a function of the weight of the user of the safety belt 22 by automatically altering the active portion of the torsion bar. In accordance with FIG. 1, at least one coupling element 6 (in this case two coupling elements 6 and 6′), which are arranged on the torsion bar 5 in such a manner that they can be adjusted in the axial direction 4 between an active position and a passive position, is provided between the locking device 3, on one side, and the connection of the torsion bar 5 to the belt roll 2, on the other side.

The active position, in which the coupling elements 6 and 6′ are rotationally fixedly connected to the torsion bar 5 on one side and the belt roll 2 on the other side, is denoted by reference designations Ib and IIb in FIG. 1. By contrast, Ia and IIa indicate the passive position, in which the coupling elements 6 and 6′ are not rotationally fixedly connected to either the belt rolls 1 or the torsion bar 5, or are rotationally fixedly connected only to the belt roll 2 and only to the torsion bar 5.

In the event of a crash, the locking device 3 blocks a rotational movement of the belt roll 2 about the axis 4, with belt tensile forces which occur after the locking twisting the torsion bar 5 about the axis 4. A torsional resistance of the torsion bar 5, which is formed as a torsionally resilient element, substantially depends on its modulus of elasticity, its cross section and a clamping length. Whereas the cross section and the modulus of elasticity of the torsion bar 5 are fixed by dimensions and material constants, the clamping length of the torsion bar 5 can be altered by axial displacement of the coupling element 6 or 6′. The result of this is that a belt retaining force can be optimally matched to driving-dynamic or biometric parameters, so that, for example, a long clamping length is selected for a vehicle occupant with a low body weight, and as a result the torsion bar 5 reacts in a more torsionally resilient manner. A soft setting of this type can be achieved, for example, by virtue of the fact that, in accordance with FIG. 1, neither of the two coupling elements 6 or 6′ or only the coupling element 6 is adjusted into the active position.

In the case of a relatively heavy vehicle occupant, the coupling element 6′ is adjusted into the active position, and as a result the available active portion of the torsion bar or the available active clamping length is greatly reduced, so that a considerably higher moment of torsional resistance of the torsion bar 5 opposes the considerably higher belt tensile force for a heavy vehicle occupant.

The adjustment of the coupling elements 6 or 6′ in this case takes place automatically and as a function of the abovementioned driving-dynamic or biometric parameters. The objective in this context is to reduce the risk of injury to the vehicle occupant by making the maximum possible use of the available distance in a vehicle interior compartment for the vehicle occupant to be thrown forward without impact during the retaining operation, without exceeding biomechanical endurance limits of the vehicle occupant.

In accordance with FIG. 1, the cross section of the torsion bar 5 is designed to decrease conically starting from its clamping location assigned to the lockable device 3. This conicity firstly promotes an adjustment movement of the coupling elements 6 and 6′ from their active position into their passive position or vice versa and at the same time offers the option of using the conicity to influence the moment of torsional resistance of the torsion bar 5. In this context, the greater the decrease in cross section of the torsion bar 5 starting from its clamping location, the softer, i.e. the more torsionally resilient, the reaction of the torsion bar 5 in the event of a crash. The conical shape of the torsion bar 5 is in this case expediently continuous, although it may also be stepped.

In accordance with FIG. 1, the coupling element 6 or 6′ has internal toothing 7 which is designed to match or be complementary to external toothing 8 of the torsion bar 5. This ensures that when the coupling elements 6, 6′ have been moved into the active position, there is a rotationally fixed, play-free connection to the torsion bar 5.

To allow the at least one coupling element 6 to be easily adjusted without problems along the axial direction 4 on the torsion bar 5, the internal toothing 7 of the coupling element 6 and the external toothing 8 of the torsion bar 5 have tooth peaks and valleys which run parallel to the axis 4 of the torsion bar 5.

In general, the coupling elements 6 and 6′ are designed as torsion-proof sleeves, which in the active position ensure rotationally fixed, play-free transmission of rotation forces from the belt roll 2 to the torsion bar 5 and vice versa.

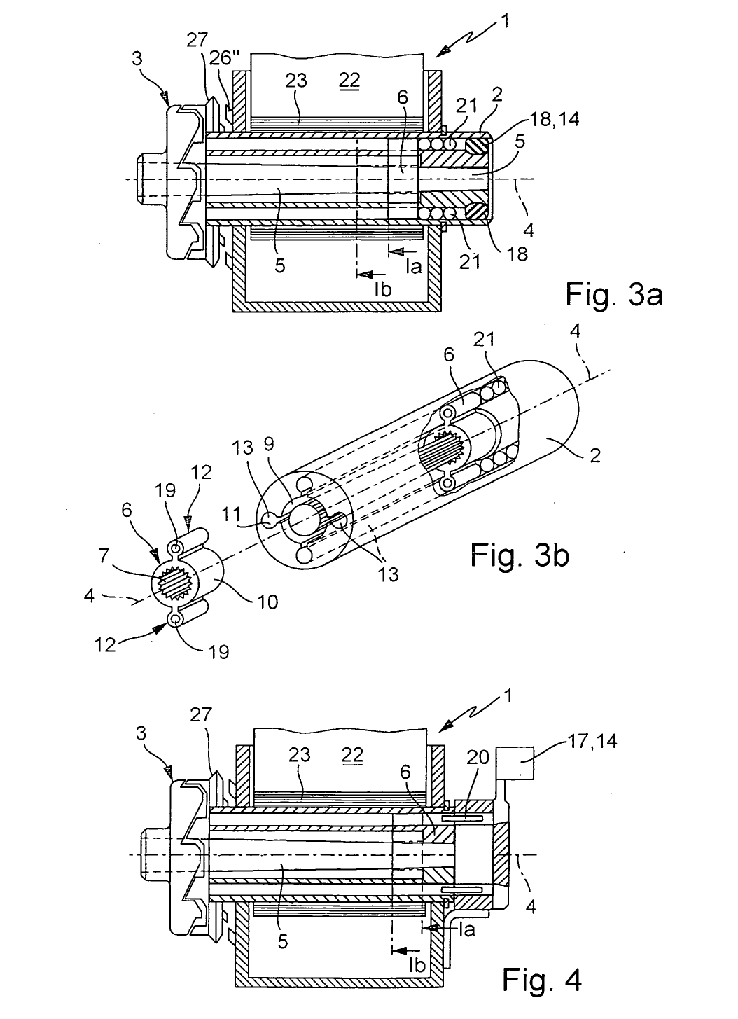

The coupling element 6 shown in FIG. 1 has a non-round external contour 10, a cavity 9 which runs inside the belt roll 2 and is formed, for example, as a stepped bore having an internal contour 11 which substantially matches the external contour 10 of the coupling element 6. The external contour 10 of the coupling element 6 or the internal contour 11 of the cavity 9 is largely cylindrical in form, with at least two projecting cams 12, which engage in corresponding recesses 13 in the cavity 9 (cf. FIG. 2 and FIG. 3b) being formed integrally on the external contour 10 of the coupling element 6. Both the cams 12 on the coupling element 6 and the recesses 13 on the belt roll 12 run parallel to the axis 4 of the torsion bar 5, thereby ensuring axial adjustment of the coupling element 6 in the belt roll 2 with simultaneous guidance of the cams 12 in the respective recesses 13. The cams 12 and the associated recesses 13 may have different shapes, for example with a uniform cross section in the radial direction (cf. FIGS. 1 and 2) or a cross section which bulges out in the radial direction. Furthermore, other cam cross sections which ensure accurate guidance of the cams 12 and therefore of the coupling element 6 in the recess 13 are also conceivable. A bulging cam shape as shown in FIG. 3b, for example, allows the use of balls 21 which are adjusted along the recess 13 and are pressed onto the coupling element 6 by a pyrotechnic actuating drive 18 in order to adjust the coupling element 6.

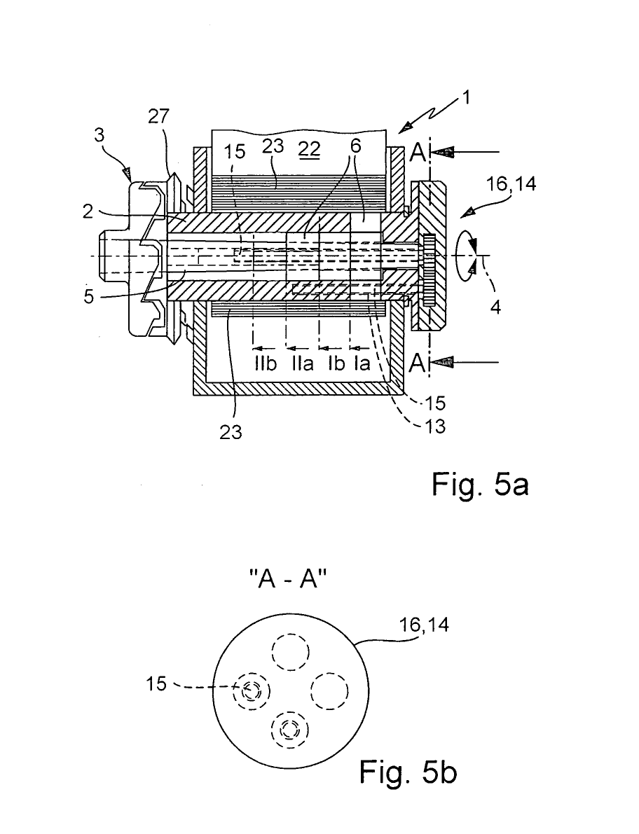

For automatic adjustment of the coupling elements 6 and 6′ coaxially with respect to the torsion bar 5, there is an actuating drive 14 which allows either reversible or irreversible movement of the coupling elements 6, 6′ from the active position into the passive position or vice versa along the axis 4. A suitable reversible actuating drive 14 is, for example, an electric motor 16 (cf. FIG. 5a) or a pneumatic drive 17 (cf. FIG. 4).

In accordance with FIG. 4, the movement of the coupling element 6 from the active position to the passive position is effected by means of a pneumatic actuating drive 17. In this case, the pneumatic drive 17 can act on the cams 12 of the coupling element 6 and move the latter coaxially with respect to the torsion bar 5 either directly or indirectly by way of slide rods 20 which are mounted slideably inside the recess 13. The slide rod 20 is connected on one side to the pneumatic drive 17 and on the other side to the cams 12 of the coupling element 6. Moreover, arranging the slide rods 20 parallel to the adjustment direction 4 of the coupling element 6 within the recess 13 also ensures that the coupling element is adjusted without tilting.

FIG. 5a shows a belt roller 1 with an actuating drive 14 designed as an electric motor 16, at least one threaded spindle 15 being provided, which on one side is mounted rotatably in a corresponding threaded bore 19 (cf FIGS. 1, 2 and 3b) in the coupling element 6 (cf FIG. 1) and on the other side is rotationally fixedly connected to a rotor of the electric motor 16. In a similar way to the slide rods 20, the threaded spindles 15 also run parallel and inside the recess 13, so that with this embodiment of the actuating drive 14 too a particularly compact design can be achieved.

FIG. 5b illustrates an electrical actuating drive 16 in cross section, which is able to control at least two coupling elements 6 (not shown in FIG. 5b) independently of one another. In this case, in each case two opposite threaded spindles 15 or slide rods 20 are assigned to one coupling element 6. A transmission mechanism (not shown) of the electrical actuating drive 16 is designed in such a way that each coupling element 6 can be adjusted independently of the other(s).

To allow two coupling elements 6 to be axially adjusted independently of one another, they are arranged circumferentially rotated with respect to one another (cf. FIG. 1 and FIG. 2). The result of this is that the associated recesses 13 of the respective coupling element 6 only have to guide the actuating elements which are required to control this coupling element 6, such as for example threaded spindles 15 or slide rods 20. If there are two coupling elements 6, 6′, the belt roll 2 expediently has four recesses 13, of which in each case two opposite recesses 13 serve to receive the threaded spindles 15 or the slide rods 20 of a coupling element 6. If more than two coupling elements 6 are provided, they are arranged circumferentially rotated, for example in each case through 60°.

The reversible actuating drive 14 has the advantage over an irreversible actuating drive 14 that after a vehicle crash, the coupling elements 6, 6′ can be moved back into the starting position by a reversal of the actuation direction, without it being necessary to replace the entire belt roller 1. Since the change in the active portion of the torsion bar and therefore the setting of the active moment of torsional resistance take place automatically, there is a control device (not shown) which uses sensors, for example pressure sensors or strain gauges in a vehicle seat, to record biometric parameters and processes these biometric parameters together with further parameters, for example driving-dynamic parameters, such as a vehicle acceleration/deceleration, to generate control signals which are emitted to the respective actuating drive 14, whereupon the actuating drive 14 controls the adjustment of the coupling elements 6, 6′ according to the parameters input into the control device.

As mentioned in the introduction, it is also conceivable for the actuating drive 14 to be designed to be irreversible, for example as a pyrotechnic drive 18. A belt roller 1 with a pyrotechnic actuating drive 18 is shown in FIG. 3a. In this case, there are balls 21 which can be pressed onto the coupling elements 6 by means of the pyrotechnic actuating drive 18 inside the recess 13. The pyrotechnic drive 18 generates an ignition, for example using an igniter, with the result that the balls 21 are shot onto the corresponding coupling element 6 in the virtually round recesses 13 (cf. FIG. 3b) and move the coupling element into an active position. A pyrotechnic drive 18 has a shorter actuation time than an electrical actuating drive 16, resulting in valuable time savings in the event of a vehicle crash.

The functioning of the belt roller 1 in the event of a vehicle crash is to be briefly outlined below:

In the event of a vehicle crash, on account of the high vehicle deceleration which occurs, a predetermined threshold value is exceeded, whereupon the locking device 3 blocks the belt roll 2 from rotating further and therefore blocks further unwinding of the safety belt 22 which is wound up on the belt roll 2. To ensure that the biomechanical endurance limits of the vehicle occupant wearing the belt are not exceeded in the event of the abrupt blocking of the unwinding movement of the safety belt 22 but at the same time the risk of injury to the vehicle occupant can be minimized, the belt roller 1 according to the invention, after the blocking of the unwinding movement by the locking device 3, allows a further but greatly reduced resilience on the part of the safety belt 22. This is achieved by the tensile force acting on the safety belt 22 being converted into a torsional movement which acts on the belt roll 2. Since the belt roll 2 is rotationally fixedly connected to a torsion bar 5 which runs in its axial direction 4 and forms a torsionally resilient element, the torsional moment which is generated is transmitted to the torsion bar 5. The torsional resistance of the torsion bar 5 is in this case dependent on material characteristic variables which cannot be subsequently influenced, such as for example the modulus of elasticity, and cross-sectional dimensions which cannot subsequently be influenced, and also variables which can subsequently be influenced, such as for example the clamping length of the torsion bar 5.

Then, an automatic change in the active portion of the torsion bar, i.e. an automatic change in the active clamping length, brings about optimum matching of the belt force to driving-dynamic and/or biometric parameters as a function of actual states determined by sensors, such as for example a vehicle seat position or the weight of the vehicle occupant. The matching of the clamping length and therefore the matching of the moment of torsional resistance of the torsion bar 5 are effected by an axial displacement of the coupling element 6 on the torsion bar 5, by which the coupling element is moved from a passive position, in which it is rotationally fixedly connected only to the belt roller 2 or only to the torsion bar 5, into an active position, in which it is rotationally fixedly connected to the torsion bar 5 on one side and the belt roll 2, on the other side, or vice versa. To adjust the at least one coupling element 6 there is a reversible or irreversible actuating drive 14 which is controlled by a control unit.

To summarize, the main features of the invention can be characterized as follows:

The invention provides for a resilience of the safety belt 22 after blocking by the locking device 3 to be controlled by a torsion bar 5 which runs in the axial direction 4 of the belt roll 2 and forms a torsionally resilient element, in order to controllably limit the belt force in the event of a vehicle crash. This is achieved by the belt roller 1 setting the maximum possible torsional resistance at least as a function of the weight of the user of the safety belt 22 through automatic alteration to the active portion of the torsion bar and thus the active moment of torsional resistance of the torsion bar 5.

For this purpose, at least one coupling element 6, which in the event of a crash can be moved by axial movement on the torsion bar 5 between an active position and a passive position, is provided between the locking device 3, on one side, and the connection of the torsion bar 5 to the belt roll 2, on the other side. In the active position, the coupling element 6 is rotationally fixedly connected on one side to the torsion bar 5 and on the other side to the belt roll 2, resulting in a reduced clamping length compared to the-passive position, in which the coupling element 6 is rotationally fixedly connected only to the belt roll 2 or only to the torsion bar 5, and therefore resulting in an increased moment of torsional resistance of the torsion bar 5.

In the event of a crash, this allows a belt force to be restricted to levels which on the one hand are matched to biometric parameters of the vehicle occupant and/or to driving-dynamic data, and on the other hand are oriented according to biomechanical endurance limits of the vehicle occupant.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1-12. (canceled)

13. A belt roller for a safety belt system in a motor vehicle which locks a belt roll in the event of a belt velocity which exceeds a threshold value and/or in the event of a vehicle deceleration/acceleration which exceeds a threshold value, comprising:
a belt roll arranged to receive a safety belt wound thereon;
a locking device which selectively prevents rotation of the belt roll;
a torsion bar, the torsion bar having a longitudinal axis parallel to an axis of rotation of the belt roll, and being connected at one end to the locking device and at the other end to the belt roll;
at least one coupling element disposed between the belt roll and the torsion bar such that the at least one coupling element is displaceable along the longitudinal axis of the torsion bar between an active position in which the at least one coupling element is rotationally fixedly connected to the torsion bar on one side and the belt roll on the other side, and a passive position in which the at least one coupling element is one of not rotationally fixedly connected to either the belt roller or the torsion bar, is rotationally fixedly connected only to the belt roller, or is rotationally fixedly connected only to the torsion bar; and
at least one actuating element arranged to displace the at least one coupling element between the active position and the passive position, wherein
an external contour of each coupling element is not round and substantially matches a corresponding internal contour of a corresponding cavity inside the belt roll, and
two axially adjacent coupling elements are arranged circumferentially rotated with respect to one another.

14. The belt roller as claimed in claim 13, wherein the cross section of the torsion bar decreases conically starting from the torsion bar connection to the locking device toward the torsion bar connection to the belt roll.

15. The belt roller as claimed in claim 13, wherein the coupling elements are torsion-proof sleeves.

16. The belt roller as claimed in claim 13, wherein
the coupling elements have internal teeth,
the torsion bar has corresponding external teeth configured to engage the coupling element internal teeth.

17. The belt roller as claimed in claim 14, wherein the coupling elements have internal teeth,
the torsion bar has corresponding external teeth configured to engage the coupling element internal teeth.

18. The belt roller as claimed in claim 16, wherein the internal teeth and the external teeth have tooth peaks and tooth valleys aligned parallel to the longitudinal axis of the torsion bar.

19. The belt roller as claimed in claim 13, wherein
the external contour of the coupling elements includes projecting cams,
the belt roll cavities are aligned parallel to the longitudinal axis of the torsion bar.

20. The belt roller as claimed in claim 18, wherein
the external contour of the coupling elements includes projecting cams,
the belt roll cavities are aligned parallel to the longitudinal axis of the torsion bar.

21. The belt roller as claimed in claim 13, wherein the at least one actuating element is driven by an actuating drive provided coaxially with the torsion bar to displace the coupling elements through their respective cavities.

22. The belt roller as claimed in claim 19, wherein the at least one actuating element is driven by an actuating drive provided coaxially with the torsion bar to displace the coupling elements through their respective cavities.

23. The belt roller as claimed in claim 21, wherein the actuating drive is reversible.

24. The belt roller as claimed in claim 23, wherein the actuating drive is one of an electric motor and pneumatic drive.

25. The belt roller as claimed in claim 21, wherein the actuating drive is irreversible.

26. The belt roller as claimed in claim 25, wherein the actuating drive is a pyrotechnic drive.

27. The belt roller as claimed in claim 23, wherein
the actuating drive is an electric motor,
for each coupling element there is at least one threaded spindle which on one side is mounted rotatably in a corresponding threaded bore in the coupling element, and on the other side is rotationally fixedly connected to a rotor of the electric motor, and
each threaded spindle is disposed in one of the at least one cavities of its respective coupling element.

28. The belt roller as claimed in claim 23, wherein
the actuating drive is at least one of a pneumatic drive and a pyrotechnic drive,
for each coupling element there is at least one slide rod which is connected on one side to the actuating drive and on the other side to the coupling element, and
each slide rod is in one of the at least one cavities of its respective coupling element.

29. The belt roller as claimed in claim 26, wherein balls are provided which can be pressed onto the coupling elements via their respective cavities by the pyrotechnic actuating drive.
